(19) United States
(12) Patent Application Publication
(10) Pub. No.: US 2013/0080468 A1
(43) Pub. Date: Mar. 28, 2013

(54) Web Browsing Data Retention

(71) Applicant: Francesco Attanasio, Roccapiemonte (SA) (IT)

(72) Inventor: Francesco Attanasio, Roccapiemonte (SA) (IT)

(73) Assignee: TELEFONAKTIEBOLAGET LM ERICSSON (PUBL), Stockholm (SE)

(21) Appl. No.: 13/702,300

(22) PCT Filed: Jun. 11, 2010
(86) PCT No.: PCT/SE2010/050654

§ 371 Date: Dec. 14, 2012

(51) Int. Cl. G06F 17/30

(52) U.S. Cl. CPC G06F 17/30979
USPC 707/769

(57) ABSTRACT

The present invention relates to a method to monitor retained data related to a web browsing session in a communication network, whereby a Multiservice Proxy (10) is acting as data retention source. The method comprises the following further steps: —Identifying in a Data Retention System (2) query requests specifying data to be accessed.—Detecting in the Data Retention System retained data received from the Multiservice Proxy that matches the query requests.—Providing a Requesting Authority (3) with the data.

### TECHNICAL FIELD

The present invention generally relates to systems, software and methods and, more particularly, to mechanisms and techniques to monitor retained data related to a web browsing session in a communication network.

### BACKGROUND

In many countries the operators and Internet service providers are today obliged by legal requirements to provide stored traffic data generated from public telecommunication and Internet services for the purpose of detection, investigation and prosecution of crime and criminal offences including terrorism. There are also a number of initiatives within the European Union EU to regulate the legal basis for data retention. The EU Parliament has recently adopted a set of amendments and by that approved the Council's proposed directive on data retention [See Directive 2006/24/EC of the European Parliament and of the Council of 15 Mar. 2006 on the retention of data generated or processed in connection with the provision of publicly available electronic communications services or of public communications networks and amending Directive 2002/58/EC]. This proposal describes not only initial requirements, but also how an extension of the directive will be handled. Consequently, an essential part of operator's effort to comply with current legislation will be to secure that processes and tools are adaptable to handle an expansion of the scope for data retention.

The ETSI document TS 102 656 V1.2.1 (2008-12) (Retained Data; Requirements of Law Enforcement Agencies for handling Retained Data) gives guidance for the delivery and associated issues of retained data of telecommunications and subscribers. It provides a set of requirements relating to handover interfaces for the retained traffic data and subscriber data by law enforcement and other authorized requesting authorities. The requirements are to support the implementation of Directive 2006/24/EC of the European Parliament and of the Council of 15 Mar. 2006 on the retention of data.

The ETSI document ETSI TS 102 657 V1.4.1 (2009-12) (Lawful Interception (LI); Retained data handling; Handover interface for the request and delivery of retained data) contains handover requirements and a handover specification for the data that is identified in EU Directive 2006/24/EC on retained data.

The Ericsson Automatic Data Retention System ADRS provides a solution for collecting, storing and delivering of communication data generated by telecommunication and Internet services in public fixed and mobile networks. FIG. 1 belongs to the prior art and shows the Handover Interfaces HIA 7 and HIB 8 between a Data Retention System DRS 2 (see ETSI TS 102 656 and ETSI TS 102 657) at a Communication Service Provider CSP 1, and a Requesting Authority RA 3. The figure shows an Administration Function AdmF 4 used to handle and forward requests from/to the RA. A Mediation and Delivery function MF/DF 5 is used to mediate and deliver requested information. Storage 6 is used to collect and retain data from external the data bases. The generic Handover Interfaces adopt a two port structure such that administrative request/response information and Retained Data Information are logically separated. The Handover Interface HIA transports various kinds of administrative, request and response information from/to the Requesting Authority and the organization at the CSP which is responsible for Retained Data matters. The Handover Interface HIB transports the retained data information from the CSP, to the Requesting Authority RA. The HIA and HIB interfaces may be crossing borders between countries. This possibility is subject to corresponding national law and/or international agreements.

ETSI don't require the retention of Web Browsing data. In particular ETSI TS 102 657 V1.4.1 (Lawful Interception (LI); Retained data handling; Handover interface for the request and delivery of retained data) covers in Annex E Network Access Services, that are services offering a capability to access public networks (typically the internet) including GPRS/UMTS-PS. Nothing is reported about web browsing. On the other side an increasing number of Law Enforcement Agencies (e.g. in Ireland, in Spain, in Lithuania, in Denmark, in Belgium . . . ) are asking telecom firms to hand over all information about which web pages people browse on their mobiles. To handle internet web browsing traffic from several networks that can be geographically or business wise separated, would require several proxy nodes integration in Data Retention Solution, entailing high operator costs.

### SUMMARY

An aim of the invention is to overcome above identified limitations of the prior art. The invention focuses on that a Multiservice Proxy is acting as data retention source.

According to one aspect of the present invention, a method is provided to monitor retained data related to a web browsing session in a communication network. A Multiservice Proxy is hereby acting as data retention source. The method further comprises the following steps:
Query requests specifying data to be accessed are identified in a Data Retention System.
Retained data received from the Multiservice Proxy that matches the query requests are detected in the Data Retention System;
The detected data are provided a Requesting Authority.

According to a further aspect of the invention an arrangement is adapted to monitor retained data related to a web browsing session.

According to yet a further aspect of the present invention, a node is configured to receive a query request specifying retained data to be accessed, which data is related to internet web browsing service received from a Multiservice Proxy (or any network node implementing such function). The node is further configured to forward the accessed data.

According to yet a further aspect of the present invention, a node is configured to send a query request specifying retained data in a Data Retention System related to internet web browsing service received from a Multiservice Proxy, and to receive the accessed data.

According to further one aspect of the invention, Handover Interfaces between a data Retention System and a Requesting Authority have been enhanced for transportation of query requests and for transportation of data related to internet web browsing service.

Some advantages of the invention are as follows:
One Data Retention System, using the multiservice proxy Virtual Gateway feature can handle Internet web browsing data from several networks that may be geographically or business wise separated.
An operator with affiliates only needs to buy one Automatic Data Retention System ADRS with integrated Multiservice Proxy node and place in a central location, which reduces operational costs.
Less administrative work, enabling the administration of several multiservice proxy sites via one operator interface, ensuring consistency by an effective way of distributing configuration parameter values to the included traffic servers.
Possibility to provide a Requesting Authority RA with accurate data related to internet browsing traffic, with a filtering out logic related to the content of communication implemented: for example, within a communication, data identifying www.homeoffice.gov.uk would be traffic data, for that reason provided to RA, whereas data identifying www.homeoffice.gov.uk/kbsearch?qt=ripa+traffic=data would be content and not provided to RA.
The operator can customize internet traffic data required for each affiliate, providing different and separated event data records to ADRS that will handover internet traffic data for each sub-operator in different and separated files to the LEAs, according to the used handover interfaces.

The invention will now be described more in detail with the aid of preferred embodiments in connection with the enclosed drawings.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is part of the prior art and discloses a block schematic illustration of a Data Retention System at a Communication Service Provider CSP attached to a Requesting Authority.

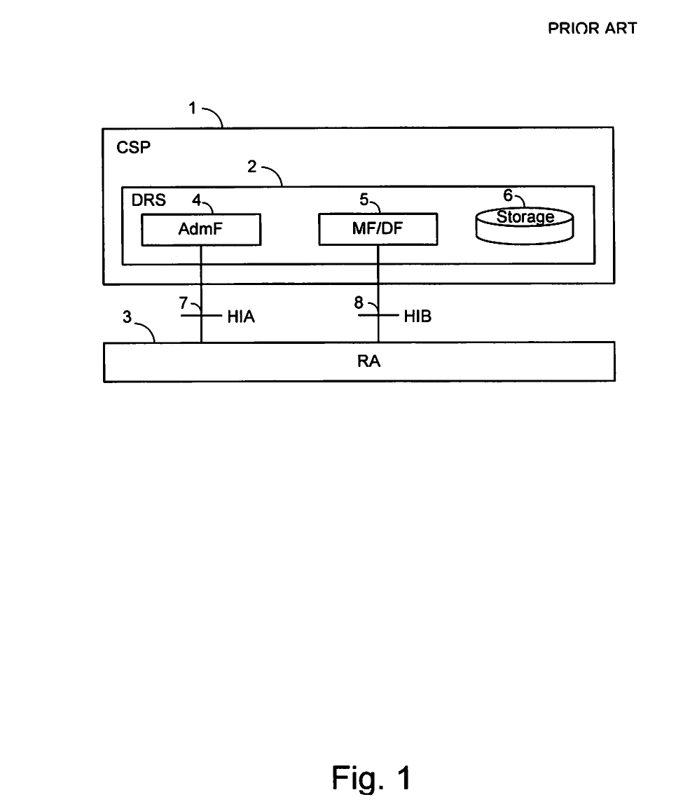

FIG. 2 belongs to prior art and is a block schematic illustration disclosing a Multiservice Proxy attached to mobile networks and to operator domain.

FIG. 3 discloses a Multiservice Proxy acting as data retention source.

FIG. 4 discloses a signal sequence diagram representing collecting and handling of various Multiservice Proxy data records in a data retention environment.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced in other embodiments that depart from these specific details. In other instances, detailed descriptions of well known methods, devices, and circuits are omitted so as not to obscure the description of the present invention with unnecessary detail.

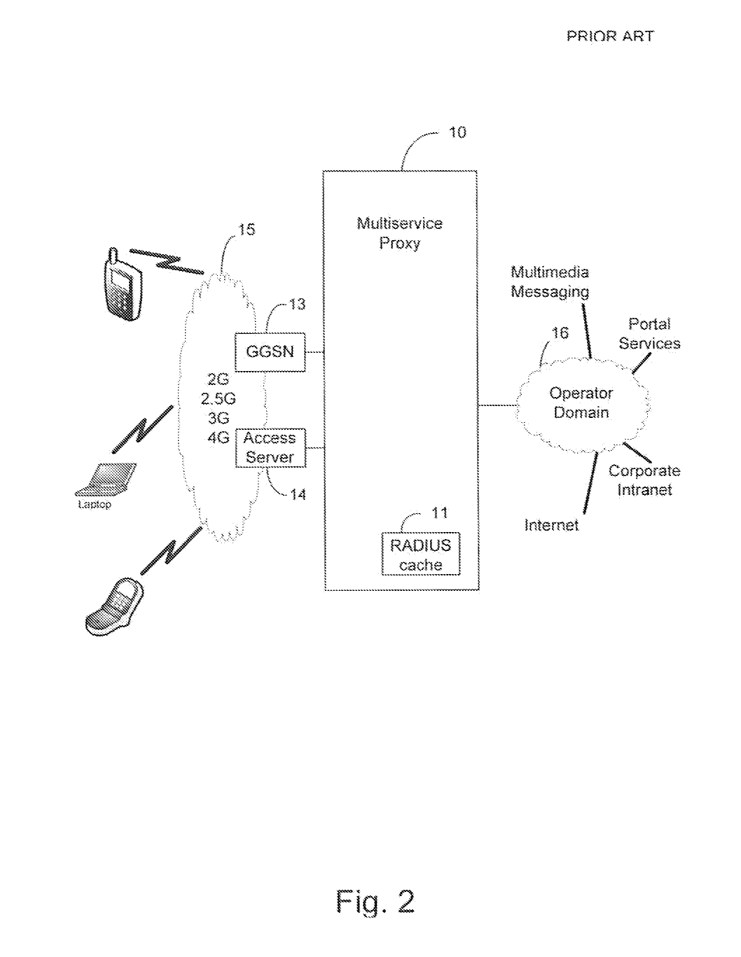

FIG. 2, that belongs to prior art, discloses a Multiservice Proxy 10. The Multiservice proxy can be deployed in a large variety of 2G, 2.5G, 3G and 4G mobile networks 15, including GSM, W-CDMA, TDMA, CDMA and LTE. The Multiservice Proxy 10 connects to a Gateway GPRS Support Node GGSN 13 for packet switched access and to an Access Server 14 for Circuit Switched Data access. Thanks to its central place in a Mobile Internet infrastructure, Multiservice Proxy is the perfect enabler for providing services such as browsing, download, streaming, multimedia messaging and WAP push from operator domain 16. The Multiservice Proxy simplifies an Operator network by offering a single-vendor solution capable of replacing several other proxies in the Operator network, thus being a true multi-service proxy. This way it reduces both capital expenditure CAPEX and operating expense OPEX. In the example in FIG. 2 the operator domain comprises services such as Multimedia Messaging, Portal Services, Corporate Intranet and Internet. To support these services, Multiservice Proxy provides a full range of proxy services, for example, user identification, user access control, content optimization and forwarding of user and network information to the service providers.

Using Virtual Gateway features, one Multiservice Proxy node can handle Internet traffic from several networks in operator domain 16—networks that may be separated geographically or in a business wise. An Operator with affiliates only needs to buy one Multiservice Proxy and place it in a central location, which reduces operational costs. The Operator can provide proxy services to their affiliate operators and sell proxy services to small operators that do not need the full capacity of a Multiservice Proxy node.

Multiservice Proxy browsing support provides the means for end-users to retrieve information from origin servers. A typical example is browsing the World Wide Web, where the end-user enters a URL into their device. The request is sent to the Multiservice Proxy and is processed by the Multiservice Proxy browsing proxy, before being sent to the origin server. The origin server answers by sending the content (a web page) to Multiservice Proxy, which then forwards it to the end user device.

Multiservice Proxy charging support allows the Operator to bill subscribers and push initiators and collect information on users based on the traffic events they generate in the Multiservice Proxy node, detailed event data records can be generated which can be post-processed in an external post processing system.

Multiservice Proxy obtains the MSISDN and additional information from the mobile network using a RADIUS Accounting protocol (RFC 2866). This protocol enables Multiservice Proxy to store the IP address allocated to the device together with the MSISDN and other related user and network attributes in a RADIUS cache 11. The information is stored prior to the receipt of a first request in a session. For each incoming request, the MSISDN and/or other parameters can be looked up in the RADIUS cache using the IP address or MSISDN as a key. The detailed data records for browsing traffic are called pull attempt records. To fill the pull attempt records with information, Multiservice Proxy uses information in the request, information stored in the RADIUS cache, and information stored in the subscriber database. Examples of information in pull attempt records to be retained are as follows, whereby examples of data to be monitored according to the invention are printed in extra bold:

| Field | Brief Description |
|---|---|
| Recording entity | MultiServiceProxy network element identity |
| Bearer | Bearer service used, SMS or UDP/IP |
| Client identity/MSISDN | User MSISDN |
| User Id | |
| Destination URL | URL from which content was retrieved. |
| Content size from terminal | Volume of data received from the terminal. |
| | Configurable to include headers. |
| Content size to terminal | Volume of data sent to the terminal. Configurable to |
| | include headers. |
| Content size from server | Volume of data received from the server. Configurable |
| | to include headers. |
| Content size to server | Volume of data sent to the server. Configurable to |
| | include headers. |
| Url duration time | The time in seconds that the user browsed the URL. |
| HTTP Method | HTTP method used. This field is empty if the HTTP |
| | method is not available. |
| Authentication | This field gives information about configured |
| | identification and authentication procedure. |
| Session Id | Id of the session to which the pull request belongs |
| Charging ID | Charging ID forwarded by Ericsson GGSN. |
| Network Access Type | Network access type, for example, GPRS IP, GSM |
| | CSD, SMS, UMTS. Derived from the NAS-IP-address. |
| NAS IP-address | IP Address of the Network Access Server. |
| NAS identifier | Identifier of the Network Access Server. |
| APN | Access Point Name |
| SGSN IP Address | IP address of the Serving GPRS Support Node. |
| E.164 of Access server | CSD Internet Access Server. |
| Source IP address | IP address allocated to terminal. |
| Destination IP address | IP address derived from Destination URL. |
| IMSI | IMSI received from GGSN |
| PPP User Name | Point-to-Point (PPP) User Name. This field is empty if |
| | the PPP User Name is not available. |
| Accounting Session Id | The unique identifier of the accounting session. |
| Accounting Authentication | The accounting authentication method. The following |
| Method | values are supported: RADIUS, Local and Remote. |
| Negotiated QOS Profile | 3GPP negotiated QoS profile. |
| Charging Characteristics | 3GPP Charging Characteristics. |
| Supplementary subscriber info | Operator-defined, supplementary subscriber |
| attr 1 | information attribute 1 |
| Supplementary subscriber info | Operator-defined, supplementary subscriber |
| attr 2 | information attribute 2 |
| Supplementary subscriber info | Operator-defined, supplementary subscriber |
| attr 3 | information attribute 3 |
| Event status | Status of the event, i.e. success or failure. |
| Return Code | HTTP response code. |
| Failure reason | Available reason for failure. The cases where this field |
| | is set include: |
| | Identification Failures |
| | Zone Access Failures |
| | . . . |
| User Agent Identification | User agent identification string as presented in |
| | WSP/HTTP header. |
| Supported character set | |
| Supported languages | |
| Content types to terminal | |
| Original Content Types | |
| Response Transformations | |
| Content Analyzer decision | |
| Response from cache | |
| HTTP Request timestamp | Time when HTTP request was sent to origin server. |
| HTTP Response timestamp | Time when HTTP response was sent from origin |
| | server. |
| Request in timestamp | Time when the first part of the request was received |
| | from the terminal. |
| Response out timestamp | Time when the last part of the response was sent to |
| | the terminal. |
| VirtualGWName | Virtual gateway name |
| VirtualGWExternalIPaddress | External IP address for Virtual GW |
| Event time stamp | Event time of recorded Mobile Internet transaction. |
| Online charging flag | Online charging flag |
| Radio Access Type | Radio access type |
| IMEI | IMEI |
| Roaming information | Roaming information |
| Service Provider Id | Service Provider Id |
| Service Type | Web Browsing,. |
| Service Id | Service Id |
| Service Price Group | Service Price Group |
| Supplementary charging info 1 | Supplementary Charging Information |
| Supplementary charging info 2 | Supplementary Charging Information |
| Supplementary charging info 3 | Supplementary Charging Information |
| Result code | Result code received from charging system |
| Units | Parameter received from the charging system, |
| | defined by parameter Unit Type. |
| Unit type | Unit type, received from the charging system. |
| Currency code | |
| Final Unit Indication | |
| Check Balance Result | |
| Request Type | |
| Original Content Type | |
| Operator Specific Attribute 1 | |
| . . . | |
| Operator Specific Attribute 10 | |

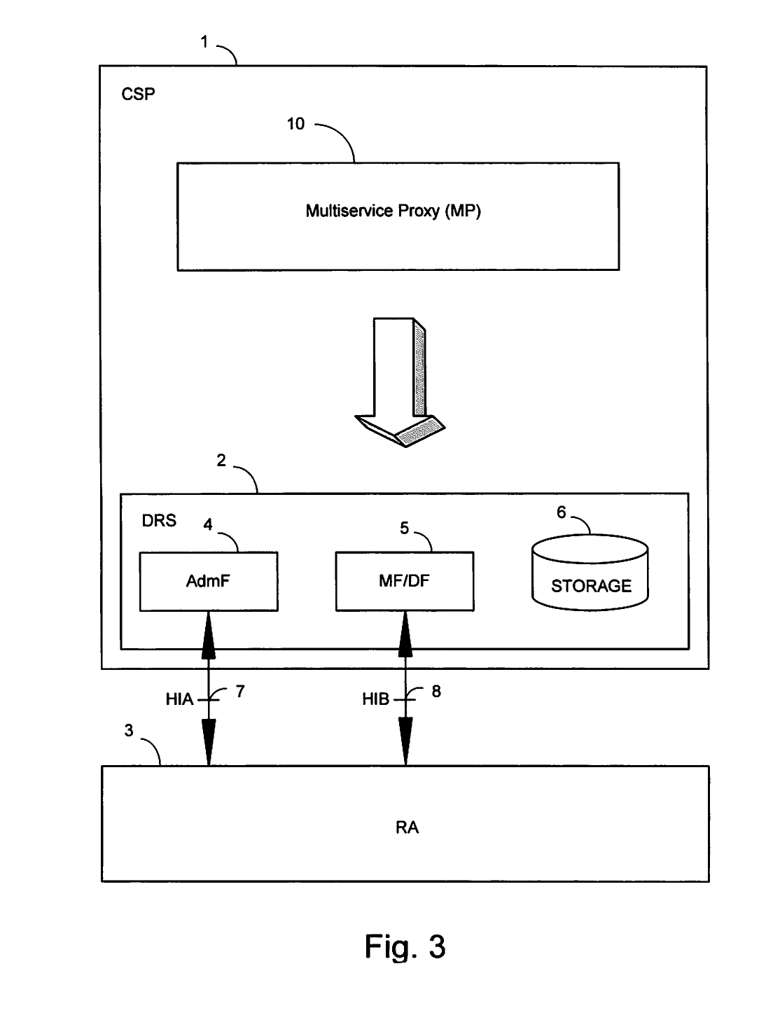

FIG. 3 discloses in a first aspect of the invention a Data Retention configuration. FIG. 3 shows the Handover Interfaces HIA 7 and HIB 8 between a Data Retention System DRS 2 at a Communication Service Provider CSP 1, and a Requesting Authority RA 3. This configuration including the AdmF 4, MF/DF 5, STORAGE 6, HIA 7, HIB 8 and RA 3 has been explained earlier in the background part of this application. The earlier explained Multiservice Proxy 10 is according to the invention acting as data retention source. The transportation of data from the data retention source i.e. from 10 to the MF/DF is schematically shown with a filled arrow in FIG. 3. Data records are transferred to the mediation function MF/DF 5 in the Data Retention System, and data fulfilling configured filtering criteria are mediated from MF/DF to the Storage 6. Updating of the Storage depends on the policy regulating the notifications with the user, session or operator related data, from the data retention source towards the storage.

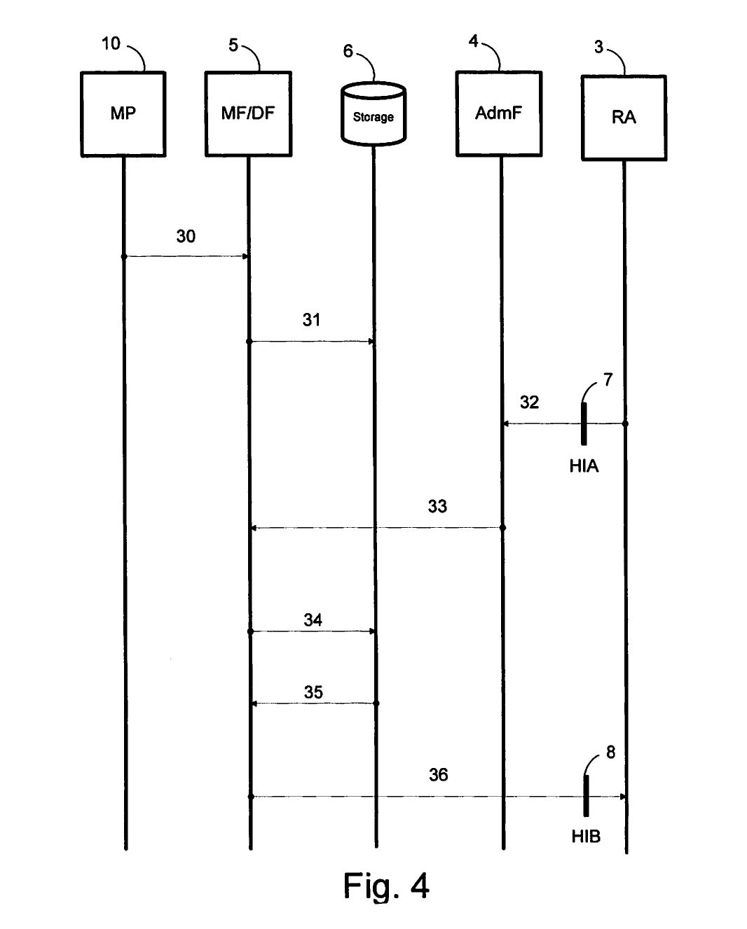

A method according to a first embodiment of the invention will now be explained together with FIG. 4. The signalling points Multiservice Proxy 10, MF/DF 5, Storage 6, ADMF 4 and RA 3 have all been shown and briefly explained earlier together with previous figures. The Handover Interfaces HIA 7 and HIB 8 have been indicated in FIG. 4. According to the invention the Handover Interface HIA 7 has been enhanced to deliver requests from RA to AdmF, which requests are related to web browsing service data. The Handover Interface HIB 8 has been enhanced to deliver the requested web browsing data. The method comprises the following steps:
In this example the following Multiservice Proxy data records have been transported 30 from the Multiservice Proxy 10 to storage 6 in the DRS, at a configured time interval:
   Web Browsing service.
   Destination URL.
   Destination IP address.
   HTTP Request timestamp.
   HTTP Response time.
Software logic is hereby implemented in the Multiservice Proxy so that this web data identifying traffic is provided. As mentioned, this is an example and also other pull data records may be transported from the Multiservice Proxy to storage.
The Data Records, after mediation in the Mediation and Delivery Function MF/DF 5, is in dependence of policy transferred 31 from MF/DF and stored in the Data Retention Storage 6.
A query request for retrieving retained information concerning visited web sites by specified MSISDNs in a specified time window is according to the invention in this example determined by the requesting Authority RA 3 and sent 32 to the Administration Function AdmF. The query request is received by the AdmF via the enhanced Handover Interface HIA 7. This request is not time correlated to the previous step and may be sent at any point of time as long as it follows after the transfer 31 in previous step.
The AdmF informs 33 the Mediation and Delivery function MF/DF 5 of the request.
The information concerning visited web sites by the specified MSISDNs is requested by a request 34 sent from the MF/DF 5 to the Storage 6.
The retained requested information concerning visited web sites by specified MSISDNs is found and transferred 35 from the Storage 6 to the Mediation and Delivery function MF/DF 5. In this example, Web Browsing service, Destination URL, Destination IP address, HTTP Request timestamp and HTTP Response time related to MSISDNs in general have been transported 30 from the Multiservice Proxy to storage and retained. Upon receiving the request to the storage 6, Web Browsing service, Destination URL, Destination IP address, HTTP Request timestamp and HTTP Response time related to the specified MSISDNs are transferred from storage 6 to MF/DF.
The fetched information is sent 36 as Message Data Records from the MF/DF 5 through the enhanced interface HIB 8, to the RA 3.

The reciprocal signaling between the above different Data Retention entities is to be seen just as example. For example can the Storage be an integrated part of the MF/DF. In this example the query requests are sent from the RA but may also be communicated by an intermediary, such as a human operator who receives the command from an authorized source, and then inputs the requests to the DRS.

In another aspect, the Multiservice Proxy allows affiliate Operators, which use a Multiservice Proxy virtual gateway as the proxy for browsing traffic, to transfer CDR information to Data Retention System. The Multiservice Proxy can be configured to store CDR data specific for each virtual gateway in separate files and folders. The SFTP transfer of these files is defined using file transfer scripts. By configuring virtual gateways and CDR for each affiliate operator, the post processing effort in the Data Retention System is minimized. An Operator can provide Data Retention services to their affiliate operators and sell web browsing DR services to small Mobile Virtual Network Operators (MVNOs) that do not need the full capacity of a Data Retention System. One physical Data Retention System node can be divided into up to several (e.g. 20) Virtual Nodes each of them hosting Data Retention functionality for a small operator. The Virtual Gateway name reported in CDRs indicates which Virtual Gateway is used. This parameter is only applicable if the virtual gateway functionality is used in the Multiservice Proxy.

A system that can be used to put the invention into practice is schematically shown in FIG. 3. Enumerated items are shown in the figure as individual elements. In actual implementations of the invention, however, they may be inseparable components of other electronic devices such as a digital computer. Thus, actions described above may be implemented in software that may be embodied in an article of manufacture that includes a program storage medium. The program storage medium includes data signal embodied in one or more of a carrier wave, a computer disk (magnetic, or optical (e.g., CD or DVD, or both), non-volatile memory, tape, a system memory, and a computer hard drive.

The systems and methods of the present invention may be implemented for example on any of the Third Generation Partnership Project (3GPP), European Telecommunications Standards Institute (ETSI), American National Standards Institute (ANSI) or other standard telecommunication network architecture. Other examples are the Institute of Electrical and Electronics Engineers (IEEE) or The Internet Engineering Task Force (IETF).

The description, for purposes of explanation and not limitation, sets forth specific details, such as particular components, electronic circuitry, techniques, etc., in order to provide an understanding of the present invention. But it will be apparent to one skilled in the art that the present invention may be practiced in other embodiments that depart from these specific details. In other instances, detailed descriptions of well-known methods, devices, and techniques, etc., are omitted so as not to obscure the description with unnecessary detail. Individual function blocks are shown in one or more figures. Those skilled in the art will appreciate that functions may be implemented using discrete components or multi-function hardware. Processing functions may be implemented using a programmed microprocessor or general-purpose computer. The invention is not limited to the above described and in the drawings shown embodiments but can be modified within the scope of the enclosed claims.

The invention is of course not limited to the above described and in the drawings shown embodiments but can be modified within the scope of the enclosed claims.

1-14. (canceled)

15. A method to monitor retained data related to a web browsing session in a communication network, wherein a multiservice proxy is acting as data retention source, the proxy comprising virtual gateways, each gateway configured for an affiliate operator as proxy for browsing traffic, the method comprising:
identifying in a data retention system query requests specifying data to be accessed;
detecting in the data retention system retained data received from the multiservice proxy, that matches the query requests; and
providing the detected data to a requesting authority.

16. The method according to claim 15, wherein the query requests are internet web browsing service data requests, which requests are sent to the data retention system from the requesting authority via a first handover interface.

17. The method according to claim 16, where the internet web browsing service data is at least one of the following:
Web Browsing service,
destination URL;
destination IP address;
HTTP request timestamp; and
HTTP response time.

18. The method according to claim 16, wherein the requested internet web browsing service data are forwarded to the requesting authority from the data retention system via a second handover interface.

19. The method according to claim 18, wherein the multiservice proxy is configured to store data specific for each virtual gateway in separate folders, in order to minimize post processing effort in the data retention system.

20. An arrangement configured to monitor retained data related to a web browsing session in a communication network, wherein a multiservice proxy is acting as data retention source, the proxy comprising virtual gateways, each gateway configured for an affiliate operator as proxy for browsing traffic, which arrangement comprising one or more processors configured to:
identify in a data retention system query requests specifying data to be accessed;
detect in the data retention system retained data received from the multiservice proxy that matches the query requests; and
provide a requesting authority with the detected data.

21. The arrangement according to claim 20, wherein the query requests are internet web browsing service data requests, and the arrangement is further configured to send the requests to the data retention system from the requesting authority via a first handover interface, and to forward the requested internet web browsing service data to the requesting authority from the data retention system via a second handover interface.

22. A data retention system comprising one or more processors configured to receive a query request specifying retained data received from a multiservice proxy to be accessed, and to provide the accessed data.

23. The data retention system according to claim 22, wherein the query request is received through a handover interface HIA.

24. The data retention system according to claim 23, wherein the handover interface HIA is located between the data retention System and a requesting authority.

25. The data retention system according to claim 24, wherein the accessed data are forwarded through a handover interface HIB.

26. The data retention System according to claim 25, wherein the handover interface HIB is located between the data retention system and the requesting authority.

27. A requesting authority comprising one or more processors configured to send a query request specifying retained data received from a multiservice proxy to a data retention system to be accessed, and to receive the accessed data.

28. A computer program product stored in a non-transitory computer readable medium for monitoring retained data related to a web browsing session in a communication network, wherein a multiservice proxy is acting as data retention source, the proxy comprising virtual gateways, each gateway configured for an affiliate operator as proxy for browsing traffic, the computer program product comprising software instructions which, when run, cause a communication service provider to:
identify in a data retention system query requests specifying data to be accessed;
detect in the data retention system retained data received from the multiservice proxy, that matches the query requests; and
send the detected data to a requesting authority.
